(19) United States
(12) Patent Application Publication
(10) Pub. No.: US 2004/0176241 A1
(43) Pub. Date: Sep. 9, 2004

(54) Benzoindenoindolyl metal catalysts for olefin polymerization

(76) Inventors: Sandor Nagy, Naperville, IL (US); Barbara M. Tsuie, Cincinnati, OH (US); Alexandr M. Genaev, Novosibirsk (RU); Vyacheslav G. Shubin, Novosibirsk (RU)

Correspondence Address: LYONDELL CHEMICAL COMPANY, 3801 WEST CHESTER PIKE, NEWTOWN SQUARE, PA, 19073, US

(21) Appl. No.: 10/379,232

(22) Filed: Mar. 4, 2003

(51) Int. Cl. C08F 4/44; B01J 31/00

(52) U.S. Cl. 502/102; 526/160; 526/127; 526/161; 526/172; 526/943; 502/103; 502/117; 502/150; 502/152; 502/153; 502/154; 502/155; 502/167; 502/168

(57) ABSTRACT

Catalyst systems that have a benzoindenoindolyl ligand are disclosed. The catalysts are useful for olefin polymerizations. They have high activity and are less susceptible to decreased activity with changes in activator level or changes in polymerization temperature. The resultant polymers have low polydispersity. A new method of preparing N-alkyldihydroindenoindoles is also disclosed. N-alkyldihydroindenoindoles are useful precursors for the benzoindenoindolyl ligand.

### FIELD OF THE INVENTION

This invention relates to catalysts that are useful for olefin polymerizations. The catalysts include an organometallic complex having a benzoindenoindolyl ligand. A method of preparing N-alkyldihydroindenoindoles is also disclosed. N-alkyldihydroindenoindoles are useful precursors for the benzoindenoindolyl ligand.

### BACKGROUND OF THE INVENTION

Catalyst precursors that incorporate a transition metal and an indenoindolyl ligand are known. U.S. Pat. Nos. 6,232,260 and 6,451,724 and WO 01/53360 disclose the use of transition metal catalysts based upon indenoindolyl ligands. Pending Appl. Ser. No. 09/859,332, filed May 17, 2001, discloses a process for polymerizing propylene in the presence of a Group 3-5 transition metal catalyst that has two non-bridged indenoindolyl ligands wherein the resulting polypropylene has isotactic and atactic stereoblock sequences. Pending Appl. Ser. No. 10/123,774, filed Apr. 16, 2002, discloses a process for polymerizing ethylene in the presence of a Group 3-10 transition metal catalyst that has two bridged indenoindolyl ligands.

Despite the considerable work that has been done with catalysts based upon indenoindolyl ligands there is a need for improvement. The present catalysts are susceptible to decreased activity as polymerization temperatures decrease or as the amount of activator decreases. There is also a need for polymers with lower polydispersity.

Regarding the synthesis of catalysts based upon N-alkylindenoindolyl ligands, they have been prepared in the above-cited references from the N-alkyl-dihydroindenoindoles. These in turn have been prepared by N-alkylation of the dihydroindenoindoles. This alkylation step is a difficult biphasic reaction with variable yields. U.S. Pat. No. 6,451,721 reports a 78% yield for the N-methylation in Example 5 and a 37% yield when making the N-allyl compound in Example 6.

Alkylation of phenylhydrazines is known. An efficient synthesis is reported in Synthesis 2 157-158 (1983). N-Methylphenylhydrazine is prepared in 89% yield, and N-allylphenylhydrazine is made in 90% yield. Another route to N-alkylphenylhydrazines (Synthetic Comm. 16(5) 585-596 (1986)) reacts phenylhydrazine with acrylonitrile to form a pyrazole which is alkylated and then hydrolyzed to the N-alkylphenylhydrazine.

Due to the difficulties in making N-alkyl-dihydroindenoindoles, there is a need for an improved synthesis.

### SUMMARY OF THE INVENTION

This invention is a catalyst which comprises an activator and an organometallic complex. The complex contains a transition metal and at least one benzoindenoindolyl ligand. The catalysts are useful for olefin polymerizations. They offer improvements in activity and polydispersity versus known indenoindolyl systems. Catalysts of the invention are less sensitive to changes in polymerization temperature or activator level compared with earlier indenoindolyl catalysts.

A new method of preparing N-alkyldihydroindenoindoles is also disclosed. N-alkyldihydroindenoindoles are useful precursors for the benzoindenoindolyl ligand. The N-alkyldihydroindenoindole is prepared by alkylation of an arylhydrazine followed by condensation with an indanone compound.

### DETAILED DESCRIPTION OF THE INVENTION

This invention is a catalyst which comprises an activator and an organometallic complex. Suitable activators include alumoxanes, alkyl aluminums, alkyl aluminum halides, anionic compounds of boron or aluminum, trialkylboron and triarylboron compounds. Examples include methyl alumoxane (MAO), polymeric MAO (PMAO), ethyl alumoxane, diisobutyl alumoxane, triethylaluminum, diethyl aluminum chloride, trimethylaluminum, triisobutylaluminum, lithium tetrakis(pentafluorophenyl) borate, lithium tetrakis(pentafluorophenyl)aluminate, dimethylanilinium tetrakis(pentafluoro-phenyl)borate, trityl tetrakis(pentafluorophenyl)borate, tris(pentafluorophenyl)-borane, triphenylborane, tri-n-octylborane, the like, and mixtures thereof.

Selection of activator depends on many factors including the organometallic complex used and the desired polymer properties. In one preferred embodiment, the organometallic complex is premixed with a solution of the activator prior to addition to the reactor. Preferably, the organometallic complex and activator solution are premixed for a period of time between ten minutes and two hours. When the organometallic complex is premixed with a solution of the activator, it is preferable to use a portion of the activator and to add the remainder of the activator to the reactor prior to the addition of the premix. In this embodiment, preferably an alkyl aluminum compound is added to the reactor prior to the addition of the premix.

The organometallic complex contains a Group 3 to 10 transition metal and at least one benzoindenoindolyl ligand. Preferably the transition metal is a Group 3-5 transition metal, more preferably a Group 4 transition metal and most preferably the transition metal is zirconium. A benzoindenoindolyl ligand derives from a benzoindenoindole compound. By “benzoindenoindole compound,” we mean an organic compound that has both indole and indene rings where the five-membered rings from each are fused, i.e., they share two carbon atoms and a benzene ring is fused to either the 6-membered ring of the indene or to the 6-membered ring of the indole.

The benzoindenoindole ligand preferably has the general structure:

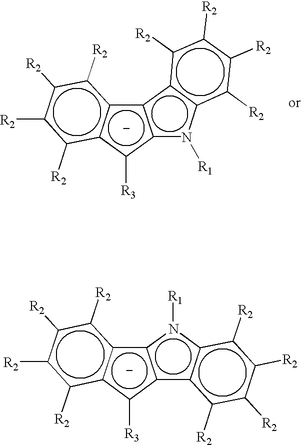

in which R₁ is selected from the group consisting of C₁-C₃₀ hydrocarbyl and trialkylsilyl; each R₂ is independently selected from the group consisting of R₁, H, Cl, Br with the proviso that at least two adjacent R₂ groups taken together are a benzo group; R₃ is selected from the group consisting of R₁, and divalent radicals connected to a second ligand wherein the divalent radical is selected from the group consisting of hydrocarbyl and heteroatom containing alkylene radicals, diorganosilyl radicals, diorganogermanium radicals and diorganotin radicals.

The benzoindenoindole ligands can be made by methods analogous to those for indenoindole. Methods for making indenoindole compounds are well known. Suitable methods and compounds are disclosed, for example, in U.S. Pat. No. 6,232,260, the teachings of which are incorporated herein by reference, and references cited therein, including the method of Buu-Hoi and Xuong, J. Chem. Soc. (1952) 2225. Suitable procedures also appear in U.S. Pat. No. 6,451,721 and PCT Int. Appl. WO 01/53360.

One new and preferred method for making indenoindole compounds is to N-alkylate an arylhydrazine and then condense the N-alkylarylhydrazine with an indanone compound. This is a preferred method for making N-alkylbenzoindenoindole ligands. The N-alkylation can be done by treatment of an arylhydrazine with base and subsequent reaction with an alkyl halide as described in Synthesis 2 157-158 (1983). The condensation with an indanone compound can be done under Fisher indole synthesis conditions such as are used for the non-alkylated hydrazines. By “indanone compound,” we mean 1-indanone, 2-indanone, or a substituted 1- or 2-indanone. Preferably the indanone compound has the structure:

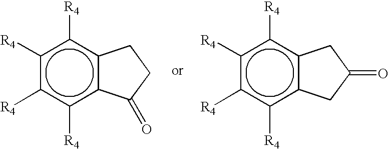

in which each R₄ is independently selected from the group consisting of hydrogen, C₁-C₃₀ hydrocarbyl, and trialkylsilyl, with the proviso that two adjacent R₄ groups taken together can be a benzo group. More preferably, at least two adjacent R₄ groups taken together form a benzo group.

Indanone compounds are well known and can be made by any suitable method. Those skilled in the art will recognize a variety of acceptable synthetic strategies. A preferred indanone compound is 6,7-benzoindan-1-one, which has the following structure:

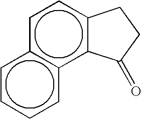

The synthesis of 6,7-benzoindan-1-one from 2-methyinaphthalene is reported in Chem. Ber. 55 1855 (1922) and from 1-indanone in Helv. Chim. Acta. 66 2377 (1983). One new and preferred method for making 6,7-benzoindan-1-one is to react naphthalene with acryloyl chloride in the presence of aluminum chloride. This is a convenient one-step procedure from readily available starting materials. Preferably, the reaction is done in the presence of a solvent at a temperature of from 0° C. to 100° C. More preferably, the reaction is done in the presence of a halogenated solvent such as trichloroethylene, methylene chloride, or 1,2-dichloroethane at a temperature of from 20° C to 80° C. Most preferably, the reaction is done in the presence of 1,2-dichloroethane at a temperature of about 50° C. Preferably, the naphthalene and acryloyl chloride are added together to a stirring mixture of aluminum chloride in solvent.

The organometallic complex contains a transition metal and at least one benzoindenoindolyl ligand. Preferably, the organometallic complex has the structure:

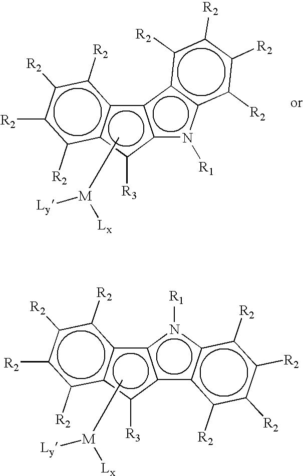

wherein M is a Group 3 to 10 transition metal; each L is independently selected from the group consisting of halide, alkoxy, siloxy, alkylamino, and C₁-C₃₀ hydrocarbyl; L′ is selected from the group consisting of substituted or unsubstituted cyclopentadienyl, fluorenyl, indenyl, boraaryl, pyrrolyl, azaborolinyl, indenoindolyl and benzoindenoindolyl; y is 0 or 1; and x+y satisfies the valence of M; R₁ is selected from the group consisting of C₁-C₃₀ hydrocarbyl and trialkylsilyl; each R₂ is independently selected from the group consisting of R₁, H, Cl, Br with the proviso that at least two adjacent R₂ groups taken together are a benzo group; R₃ is selected from the group consisting of R₁ and divalent radicals connected to a second ligand wherein the divalent radical is selected from the group consisting of hydrocarbyl and heteroatom containing alkylene radicals, diorganosilyl radicals, diorganogermanium radicals and diorganotin radicals.

The complexes can be made by any suitable method; those skilled in the art will recognize a variety of acceptable synthetic strategies. Often, the synthesis begins with preparation of the desired benzoindenoindole compound from particular indanone and arylhydrazine precursors. In one convenient approach, the benzoindenoindole is deprotonated with at least one equivalent of a potent base such as lithium diisopropylamide, n-butyllithium, sodium hydride, a Grignard reagent, or the like. The resulting benzoindenoindolyl anion is reacted with a Group 3 to 10 transition or lanthanide metal source to produce an organometallic complex. The complex comprises the metal, M, and at least one benzoindenoindolyl ligand that is bonded to the metal.

Any convenient source of the Group 3 to 10 transition or lanthanide metal can be used. Usually, the source is a complex that contains one or more labile ligands that are easily displaced by the benzoindenoindolyl anion. Examples are halides (e.g., TiCl₄, ZrCl₄), alkoxides, amides, and the like. The metal source can incorporate one or more of the polymerization-stable anionic ligands described earlier. The organometallic complex can be used “as is.” Often, however, the complex is converted to an alkyl derivative by treating it with an alkylating agent such as methyl lithium. The alkylated complexes are more suitable for use with certain activators (e.g., ionic borates).

In another approach to making the complex a synthetic equivalent of a benzoindenoindolyl anion reacts with the Group 3-10 transition metal source. By “synthetic equivalent,” we mean a neutral compound capable of generating an anionic benzoindenoindolyl ligand under the reaction conditions. When combined with suitable transition metal sources, particularly ones that have a labile anionic group such as halide or dialkylamino, a complex incorporating a benzoindenoindolyl ligand is produced with elimination of a neutral Sn, Ge, or Si-containing by-product. Usually, it suffices to combine the synthetic equivalent and the transition metal source in a suitable solvent and heat if needed to complete the reaction. Preferred synthetic equivalents have the structure:

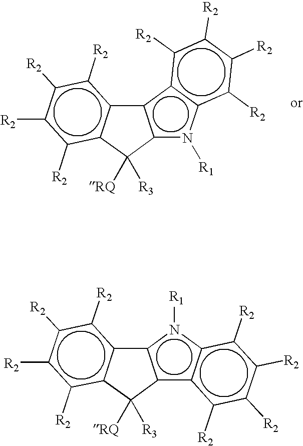

in which R₁ is selected from the group consisting of C₁-C₃₀ hydrocarbyl and trialkylsilyl; each R₂ is independently selected from the group consisting of R₁, H, Cl, Br with the proviso that at least two adjacent R₂ groups taken together are a benzo group; R₃ is selected from the group consisting of R₁ and divalent radicals connected to a second ligand wherein the divalent radical is selected from the group consisting of hydrocarbyl and heteroatom containing alkylene radicals, diorganosilyl radicals, diorganogermanium radicals and diorganotin radicals; Q is selected from the group consisting of Si, Sn and Ge; and R″ is a C₁-C₃₀ hydrocarbyl group.

For more examples of suitable synthetic equivalents, see Chem. Ber. 122 (1989)1057 and J. Organometal. Chem. 249 (1983) 23.

The catalysts are particularly valuable for polymerizing olefins. Preferred olefins are ethylene and C₃-C₂₀ alpha-olefins such as propylene, 1-butene, 1-hexene, 1-octene, and the like. Mixtures of olefins can be used. Propylene, ethylene and mixtures of ethylene with C₃-C₁₀ alpha-olefins are especially preferred.

Many types of olefin polymerization processes can be used. Preferably, the process is practiced in the liquid phase, which can include slurry, solution, suspension, or bulk processes, or a combination of these. High-pressure fluid phase or gas phase techniques can also be used. The process of the invention is particularly valuable for solution and slurry processes. Suitable methods for polymerizing olefins using the catalysts of the invention are described, for example, in U.S. Pat. Nos. 5,902,866, 5,637,659, and 5,539,124, the teachings of which are incorporated herein by reference.

The olefin polymerizations can be performed over a wide temperature range, such as about −30° C. to about 280° C. A more preferred range is from about 30° C. to about 180° C.; most preferred is the range from about 60° C. to about 100° C.

Catalyst concentrations used for the olefin polymerization depend on many factors. Preferably, however, the concentration ranges from about 0.01 micromoles per liter to about 100 micromoles per liter. Polymerization times depend on the type of process, the catalyst concentration, and other factors. Generally, polymerizations are complete within several seconds to several hours.

Optionally, the catalyst is immobilized on a support. The support is preferably a porous material such as inorganic oxides and chlorides, and organic polymer resins. Preferred inorganic oxides include oxides of Group 2, 3, 4, 5, 13, or 14 elements. Preferred supports include silica, alumina, silica-aluminas, magnesias, titania, zirconia, magnesium chloride, and crosslinked polystyrene.

The following examples merely illustrate the invention. Those skilled in the art will recognize many variations that are within the spirit of the invention and scope of the claims.

### EXAMPLE 1

### Preparation of 6,7-Benzoindan-1-one

Naphthalene (2.56 g, 20 mmol), acryloyl chloride (1.59 mL, 20 mmol), and hydroquinone (10 mg) were all dissolved in dichloroethane and the solution added dropwise over 30 minutes with stirring to a mixture of granular aluminum chloride (2.67 g, 20 mmol) and dichloroethane. After 20 hours stirring at room temperature, the reaction mixture was poured into a mixture of ice (30 g) and concentrated hydrochloric acid (2 mL). The organic layer was washed with water, dried with anhydrous calcium chloride, and filtered through alumina. Upon evaporation, a black tar (3.7 g) was obtained which upon sublimation (1 mm Hg) yielded 1.23 g (34% yield) of 6,7-benzoindan-1-one as light yellow crystals. ¹H NMR spectrum (CDCl₃, 200 MHz): 2.7-2.8 (m, 2H), 3.1-3.2 (m, 2H), 7.4-7.7 (m, 3H), 7.85 (d, 1H), 7.98 (d, 1H), 9.14 (d, 1H).

This example illustrates a convenient one-step process to prepare 6,7-benzoindan-1 -one from naphthalene.

### EXAMPLE 2

### Preparation of 1-Methyl-1-phenylhydrazine hydrochloride

n-Butyllithium in hexane (30 mL, conc. 3.25 M) was added dropwise under inert atmosphere to a solution of phenylhydrazine (3.2 mL, 32.5 mmol) in dry benzene (30 mL). After additional stirring for one hour at room temperature, a solution of methyl iodide (2.0 mL, 32.5 mmol) in benzene (5 mL) was added dropwise to the reaction mixture. Water (20 mL) was added to the suspension. The organic layer was separated, washed with water, brine and dried with sodium hydroxide. The solvent was removed to give 4.24 g of a yellow-brown liquid which was dissolved in dry ether (40 mL). To this solution, 5 mL of 10 N solution of hydrochloric acid in methanol was added. Crystals formed; these were filtered and dried in vacuo to afford 3.5 g of 1-methyl-1-phenylhydrazine hydrochloride (68% yield). ¹H NMR spectrum (DMSO-d₆, 200 MHz): 3.04 (s, 3H), 6.82 (t, 1H), 7.04 (d, 2H), 7.22 (t, 2H), 10.1 (br.s, 4H, NH+H₂O).

### EXAMPLE 3

### Preparation of 3,4-Benzo-5,10-dihydrido-5-methyl-indeno[1,2-b]indole 3

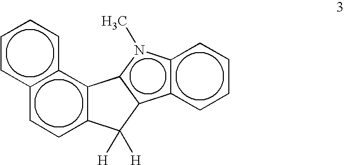

Concentrated hydrochloric acid (0.47 mL, 5.5 mmol) was added to a mixture of the indanone from Example 1 (1.00 g, 5.5 mmol) and the hydrazine hydrochloride from Example 2 (0.87 g, 5.5 mmol) in hot ethanol (11 mL). The reaction mixture was boiled for 3 hours. Upon cooling, crystals formed which were filtered and washed with 3 mL of ethanol to afford 0.89 g of 3 (60% yield). ¹H NMR spectrum (CDCl₃, 400 MHz): 3.62 (s, 2H), 4.15 (s, 3H), 7.2-7.8 (m, 8H), 7.97 (d, 1H), 8.58 (d, 1H). ¹³C NMR spectrum (CDCl₃, 100 MHz): 30.3 t, 34.7 q, 110.3 d, 1-18.6 d, 119.7 d, 122.9 s, 123.8 s, 123.9 d, 124.6 d, 125.25 d, 125.27 d, 125.4 d, 126.3 s, 129.0 d, 132.6 s,133.6 s,142.9 s,146.4 s, 146.5 s.

Examples 2 and 3 show that when the arylhydrazine is alkylated and then condensed with an indanone compound, a benzoindenoindole can be conveniently prepared in good yield.

### EXAMPLE 4

### Preparation of [1,1-Dimethyl-1-(cyclopentadienyl)silyl]-3,4-benzo-5,10-dihydrido-5-methyl-indeno[1,2-b]indolylzirconium dichloride 4-3

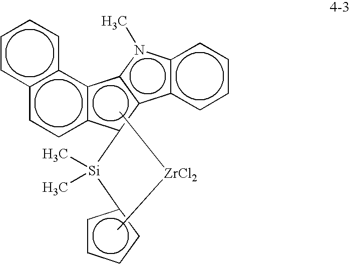

(a) Reaction with dichlorodimethylsilane to give 4-1 A suspension of 3 (2.00 g, 7.43 mmol) in benzene (20 mL) was heated to boiling to dissolve the solids and was cooled under an inert atmosphere to room temperature. To this solution was added, dropwise over five minutes, 3.5 mL of 3.25 N n-butyllithium in hexane. The reaction mixture was stirred for one hour at room temperature and to the resulting suspension, 5 mL of diethylether was added to form a solution which was added dropwise to a solution of 4.5 mL (37 mmol) dichlorodimethylsilane in ether (30 mL). The reaction mixture was stirred at room temperature for 2 hours and filtered under inert atmosphere. Solvent was removed to afford 2.88 g of 4-1 as a thick brown tar. ¹H NMR spectrum (CDCl₃, 200 MHz): 0.01 (s, 3H), 0.42 (s, 3H), 4.11 (s, 1H), 4.31 (s, 3H), 7.2-8.1 (m,9H), 8.73 (d, 1H). ¹³C NMR (CDCl₃, 50 MHz):−1.01 q, 0.99 q, 35.1 q, 39.0 d, 110.4 d 119.7 d, 120.0 d, 121.7 d, 122.8 s, 123.2 s, 124.0 d, 124.8 d, 124.9 d, 126.5 s, 129.1 d, 130.7 s,133.0 s, 143.4 s, 145.9 s,146.2 s.

(b) Reaction of 4-1 with sodium cyclopentadienide to give 4-2 A 2.38 N solution of sodium cyclopentadienide in tetrahydrofuran (3.18 mL, 7.56 mmol) was added to the solution of 4-1 (7.4 mmol) in ether (50 mL) cooled to -100° C. The resulting solution was heated to room temperature and stirred for 5 hours. After adding water (20 mL), the organic layer was separated and the water layer was extracted with ether (2×15 mL). The combined organic solution was concentrated and purified by chromatography (alumina eluted with hexane-ether 10:1 v/v) to give 4-2 as light-yellow crystals (1.86 g, yield 65% from 3). ¹H NMR showed that a mixture of the three isomers of 4-2 was formed. ¹H NMR spectrum of the major isomer (CDCl₃, 200 MHz):−0.22 (s, 3H), −0.17 (s, 3H), 3.5 (br.s, 1H), 3.94 (s, 1H), 4.30 (s, 3H), 6.1-6.8 (m, 4H), 7.1-7.8 (m, 8H), 7.98 (d, 1H), 8.76 (d, 1H).

(c) Preparation of [1,1-Dimethyl-1-(cyclopentadienyl)silyl]-3,4-benzo-5,10-dihydrido-5-methyl-indeno[1,2-blindolylzirconium dichloride 4-3. A 3.25 N solution of n-butyllithium (3.0 mL, 9.8 mmol) was added dropwise under stirring to the solution of 4-2 (1.8 g, 4.6 mmol) under inert atmosphere. A voluminous precipitate appeared. After stirring for 5 hours at room temperature, diethylether (10 mL) was added dropwise to the reaction mixture and stirring was continued for an additional 5 hours. The resulting red solution was added dropwise to a stirring mixture of zirconium(IV) chloride (1.07 g, 4.6 mmol.) in 50 mL of benzene and 12 mL of diethylether. After stirring ten hours at room temperature an orange precipitate appeared. Evaporation of the solution followed by washing the residue with hexane (50 mL) and drying in vacuo (0.6 mm Hg) for 48 hours gave 4-3 as orange crystals of a 1:1 complex with diethyl ether. ¹H NMR spectrum (CDCl₃, 200 MHz): 1.16 (t, 6H), 1.21 (s, 3H), 1.31 (s, 3H), 3.44 (q, 4H), 4.50 (s, 3H), 5.63 (q, J 2 Hz, 1H), 5.93 (q, J 2 Hz, 1H), 6.46 (q, J 2 Hz, 1H), 6.52 (q, J 2 Hz, 1H), 7.2-7.6 (m, 4H), 7.69 (t, 1H), 7.85 (d, 1H), 8.05 (d,1H), 8.74 (d, 1H).

### COMPARATIVE EXAMPLE 5

### Preparation of [1,1-Dimethyl-1-(cyclopentadienyl)silyl]-5,10-dihydrido-5-methyl-indeno[1,2-b]indolylzirconium dichloride 5-6

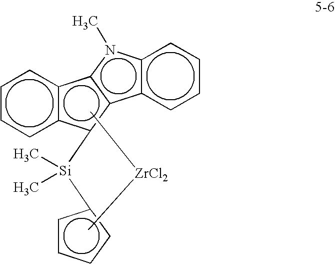

The non-benzo indenoindolyl complex 5-6 was prepared starting with 1-indanone and phenylhydrazine and performing an N-alkylation on the resulting indenoindole.

(a) Preparation of 4-methyl-5,10-dihydroindenof1,2-blindole 5-1 A 1L 3 neck flask equipped with mechanical stirrer, reflux condenser, and glass stopper was charged with 1-indanone (46.1 g, 0.35 mol) and p-tolylhydrazine hydrochloride (55.5 g, 0.35 mol). Ethanol (550 mL) was added, and the mixture was heated to gentle reflux with vigorous stirring to afford an orange slurry. Concentrated hydrochloric acid (30 mL) was added, the mixture was heated to full reflux with stirring, and a precipitate formed within 10 minutes. The mixture was refiuxed for 3 hours and cooled to room temperature. The slurry was filtered and washed with ethanol (300 mL), followed by 20% ethanol in water (400 mL) and hexanes (200 mL) to afford an off-white solid (63.3 g, 82.5%).

(b) Preparation of 3, N-dimethyl-5,10-dihydroindeno1,2-blindole 5-2 A 1 L 3 neck flask equipped with mechanical stirrer, reflux condenser, and dropping addition funnel was charged with sodium hydroxide (89.0 g, 2.22 mol) dissolved in water (112 mL) and C₁₆H₃₃NMe₃Br (0.65 g, 1.8 mmol) as a phase transfer catalyst. Compound 5-1 (36.5 g, 0.17 mol) was added followed by toluene (112 mL) with vigorous stirring. Methyl iodide (17.0 mL, 0.27 mol) in toluene (15 mL) was added dropwise, the mixture turned pale beige and was heated to reflux for 3 hours and cooled to room temperature. The mixture was filtered to afford a pale yellow crystalline solid. The filtrate was separated, the aqueous layer washed with toluene (2×100 mL), and the organic layers were combined, dried over sodium sulfate, filtered, and concentrated until a solid formed, which was washed with chilled (−78° C.) ethanol (200 mL) and hexanes (100 mL) to afford a yellow solid. ¹H NMR revealed that both the crystalline material (17.0 g) and the precipitated solid (8.8 g) were compound 5-2 (total 25.8 g, combined yield: 66.3%).

(c) N-methyl-5,10-dihydroindeno[1,2-b]indol-10-vllithium 5-3 A 500 mL flask equipped with stir bar was charged with 5-2 (14.22 g, 60.94 mmol) and dissolved in toluene (175 mL) to afford an orange solution. n-Butyllithium (38.0 mL, 2.5 M in hexanes, 95.0 mmol) was added by syringe under vigorous stirring at room temperature, and the solution turned red. A precipitate formed after 1 hour, and the mixture was maintained overnight and filtered and washed with toluene (100 mL). The yellow-orange solid was dried under vacuum (14.2 g, 97.1%).

(d) Reaction with dichlorodimethylsilane to give 5-4 Diethylether (115 mL) was added dropwise at room temperature to a slurry of 5-3 (9.87 g, 41.3 mmol) in toluene (110 mL) to afford an orange solution. The solution was added dropwise with vigorous stirring to dichlorodimethylsilane (25.0 mL, 206 mmol) in diethylether (200 mL) at 0° C. The mixture turned cloudy dirty beige and was maintained at room temperature for 2 days and filtered over a pad of Celite to yield a dark red filtrate. The volatiles were removed under vacuum to afford 5-4 as a white solid (12.6 g, 93.8%).

(e) Reaction of 5-4 with sodium cyclopentadienide and subsequent formation of the dianion 5-5 A 500 mL flask with stir bar was charged with 5-4 (6.14 g, 18.8 mmol) and diethylether (200 mL), and the red solution was placed under nitrogen and cooled to −78° C. Sodium cyclopentadienide (9.6 mL, 2M in THF, 19.2 mmol) was added by syringe, and a precipitate formed immediately. The mixture was allowed to warm to room temperature overnight. The mixture was washed with water (100 mL), and the layers were separated. The organic layer was dried over sodium sulfate for an hour and filtered. The volatiles were removed under vacuum to afford an oil. ¹H NMR was consistent with the desired product and the oil was used as isolated. The oil was dissolved in diethylether (225 mL) and cooled to −78° C. n-Butyllithium (16.0 mL, 2.5 M in hexanes, 40.0 mmol) was added under nitrogen, and a precipitate formed immediately. The cold bath was removed, and the dark yellow slurry warmed to room temperature and stirred for 48 hours. The volatiles were removed under reduced pressure to afford a yellow-orange solid (6.63 g, 99.1%).

(f) Preparation of the non-benzo indenoindolyl complex 5-6 A 500 mL flask with stir bar was charged with zirconium(IV) chloride (5.03 g, 21.6 mmol) and toluene (250 mL) was added followed by diethylether (50 mL) to afford a water-white solution. Dianion 5-5 (7.95 g, 21.6 mmol) was added at room temperature as a solid over the course of 30 minutes, and the solution turned cloudy and deep orange. The mixture was maintained at room temperature for 48 hours and was filtered to afford 5-6 as an orange solid (9.70 g, 87%).

### EXAMPLE 6

### Polymerization

Crossfield ES757 silica was calcined at 250° C. for 12 hours. In a glove-box under nitrogen, a 30 wt. % solution of methylalumoxane (MAO) in toluene (1.68 mL) was slowly added to 0.010 g of benzoindenoindolyl complex 4-4 from Example 4. The resulting solution was added slowly at room temperature with stirring to 1 g of the calcined silica resulting in flowing supported catalyst. The total aluminum to zirconium molar ratio in the catalyst was 400:1

A 2-L stainless steel polymerization reactor was pressure purged with dry nitrogen three times at 70° C. After completely venting the reactor, hydrogen was added as a 1.4 MPa pressure drop from a 7-mL vessel. A solution of 100 mL 1-hexene and 1L isobutane and 1 mmol triethyl aluminum was added to the reactor followed by 0.25 g of the supported complex. Ethylene was added to give a total reactor pressure of 2.4 MPa. Temperature was maintained at 70° C. and ethylene pressure was fed on demand to maintain 2.4 MPa for 60 minutes. After 60 minutes of polymerization, the reactor was vented to remove the volatiles. The polymer was removed from the reactor. From the weight of the polymer, the activity was calculated to be 690 kg polymer per g zirconium per hour. The weight average (M_{w}) molecular weight and polydispersity (M_{w}/Mₙ) of the polymer were measured by gel permeation chromatography (GPC) using 1,3,5-trichlorobenzene at 145° C. to be 127,000 and 3.79. Polymer density was determined by ASTM D-1505 to be 0.9197 g/mL. The melt index (MI) was measured according to ASTM D-1238, Condition E to be 0.12 dg/min. and the melting point was determined by differential scanning calorimetry to be 109° C.

### COMPARATIVE EXAMPLES 7, 9 and 11 and EXAMPLES 8,10 and 12

### Polymerizations

Comparative Examples 7, 9 and 11 and Examples 8, 10 and 12 were run in similar fashion as Example 6, but varying in the choice of complex, polymerization temperature, amount of activator, amount of hydrogen and amount of hexene. For Comparative Examples 7, 9 and 11, the non-benzo indenoindolyl complex 5-6 prepared in Comparative Example 5 was used and for Examples 8, 10 and 12 the benzoindenoindolyl complex 4-4 from Example 4 was used. The conditions and results are listed in Table 1.

TABLE 1
Polymerizations

| | Run | Al/ | Hexene | H₂ pressure | | M_{w}/ | M_{w}/ | | Mp |
|---|---|---|---|---|---|---|---|---|---|
| Ex. | Temp. ° C. | Zr | (mL) | drop (Mpa) | Activity | 1000 | Mₙ | density | ° C. |
| 6 | 70 | 400 | 100 | 1.4 | 690 | 127 | 3.8 | 0.9197 | 109 |
| C7 | 70 | 400 | 100 | 1.4 | 280 | | | 0.9229 | 108 |
| 8 | 70 | 200 | 100 | 0.7 | 810 | 128 | 3.9 | 0.9186 | 108 |
| C9 | 70 | 200 | 100 | 0.7 | 120 | 198 | 4.2 | 0.9146 | 103 |
| 10 | 80 | 200 | 55 | 0.7 | 420 | 96 | 3.5 | 0.9329 | 117 |
| C11 | 80 | 400 | 55 | 0.7 | 450 | 133 | 4.7 | 0.9241 | 112 |
| 12 | 80 | 400 | 55 | 0.7 | 410 | 97 | 3.5 | 0.9255 | 115 |

The polymerization processes of the invention exhibit good activity even at low temperatures and low levels of activator. They also result in a polymer with lower polydispersity.

At the lower polymerization temperature (70° C.), Example 6 has good activity while Comparative Example 7 has much lower activity. As the amount of activator is decreased, Example 8 retains its good activity while the activity in Comparative Example 9 decreases significantly. At a lower comonomer level, Examples 10 and 12 have lower polydispersity than Comparative Example 11. This is also true at the higher comonomer level as Examples 6 and 8 have lower polydispersity than Comparative Example 9.

The preceding examples are meant only as illustrations. The following claims define the invention.

We claim:

1. A catalyst which comprises:
(a) an activator; and
(b) an organometallic complex comprising a Group 3 to 10 transition metal, M, and at least one benzoindenoindolyl ligand that is bonded to M.

2. The catalyst of claim 1 wherein the activator is selected from the group consisting of alumoxanes, alkylaluminum compounds, organoboranes, ionic borates, ionic aluminates and aluminoboronates.

3. The catalyst of claim 1 wherein the complex incorporates a Group 4 transition metal.

4. The catalyst of claim 1 wherein the benzoindenoindolyl ligand is bridged to another ligand.

5. The catalyst of claim 1 wherein the benzoindenoindolyl ligand has a structure selected from the group consisting of: 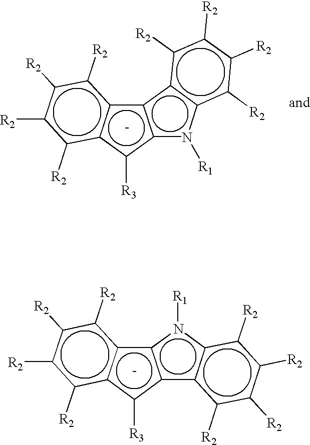
in which R₁ is selected from the group consisting of C₁-C₃₀ hydrocarbyl and trialkylsilyl; each R₂ is independently selected from the group consisting of R₁, H, Cl, Br with the proviso that at least two adjacent R₂ groups taken together are a benzo group; R₃ is selected from the group consisting of R₁ and divalent radicals connected to a second ligand wherein the divalent radical is selected from the group consisting of hydrocarbyl and heteroatom containing alkylene radicals, diorganosilyl radicals, diorganogermanium radicals and diorganotin radicals.

6. The catalyst of claim 1 wherein the complex has a structure selected from the group consisting of: 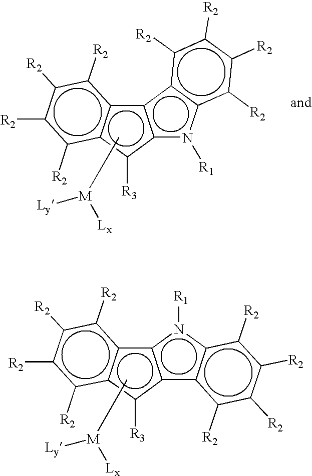
wherein M is a Group 3 to 10 transition metal; each L is independently selected from the group consisting of halide, alkoxy, siloxy, alkylamino, and C₁-C₃₀ hydrocarbyl; L′ is selected from the group consisting of substituted or unsubstituted cyclopentadienyl, fluorenyl, indenyl, boraaryl, pyrrolyl, azaborolinyl, indenoindolyl and benzoindenoindolyl; y is 0 or 1; and x+y satisfies the valence of M; R₁ is selected from the group consisting of C₁-C₃₀ hydrocarbyl and trialkylsilyl; each R₂ is independently selected from the group consisting of R₁, H, Cl, Br with the proviso that at least two adjacent R₂ groups taken together are a benzo group; R₃ is selected from the group consisting of R₁ and divalent radicals connected to a second ligand wherein the divalent radical is selected from the group consisting of hydrocarbyl and heteroatom containing alkylene radicals, diorganosilyl radicals, diorganogermanium radicals and diorganotin radicals.

7. The catalyst of claim 6 wherein L′ is covalently bonded to the benzoindenoindolyl ligand.

8. A method of producing the catalyst of claim 1 which comprises:
(a) deprotonating a benzoindenoindole and reacting the resulting anion with a Group 3 to 10 transition metal source to produce the organometallic complex,, and
(b) combining the complex with an activator.

9. A method which comprises reacting a synthetic equivalent of a benzoindenoindolyl anion with a Group 3 to 10 transition metal source to produce an organometallic complex comprising the metal, M, and at least one benzoindenoindolyl ligand that is bonded to M.

10. The method of claim 9 wherein the synthetic equivalent has a structure selected from the group consisting of: 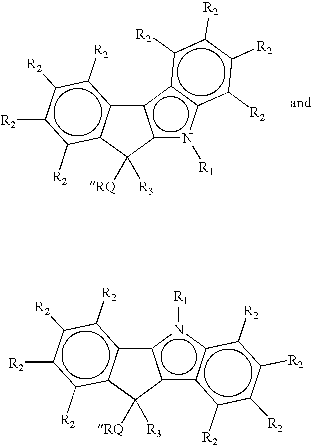
in which R₁ is selected from the group consisting of C₁-C₃₀ hydrocarbyl and trialkylsilyl; each R₂ is independently selected from the group consisting of R₁, H, Cl, Br with the proviso that at least two adjacent R₂ groups taken together are a benzo group; R₃ is selected from the group consisting of R₁ and divalent radicals connected to a second ligand wherein the divalent radical is selected from the group consisting of hydrocarbyl and heteroatom containing alkylene radicals, diorganosilyl radicals, diorganogermanium radicals and diorganotin radicals; Q is selected from the group consisting of Si, Sn and Ge; and R″ is a C₁-C₃₀ hydrocarbyl group.

11. A supported catalyst of claim 1.

12. A process which comprises polymerizing an olefin in the presence of the catalyst of claim 1.

13. The process of claim 12 wherein the olefin is propylene.

14. The process of claim 12 wherein the olefin is a mixture of ethylene and a C3 -C₁₀ alpha-olefin.

15. A method of preparing an N-alkyldihydroindenoindole by alkylating an aryl hydrazine to produce a 1-alkylarylhydrazine, followed by condensation of the 1-alkylarylhydrazine with an indanone compound.

16. The method of claim 15 wherein the N-alkyldihydroindenoindole is an N-alkylbenzodihydroindenoindole.

17. A method which comprises preparing 6,7-benzoindan-1-one by reacting naphthalene and acryloyl chloride in the presence of aluminum chloride.
